(19) United States
(12) Patent Application Publication
(10) Pub. No.: US 2002/0017982 A1
(43) Pub. Date: Feb. 14, 2002

(54) Switch's click tone output unit, switch's click tone outputting method, and audio unit for the switch's click tone output unit

(75) Inventors: Hiroshi Nishiyama, Shizuoka (JP); Fumie Mukasa, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo (JP)

(21) Appl. No.: 09/875,182

(22) Filed: Jun. 7, 2001

(30) Foreign Application Priority Data
Jun. 8, 2000 (JP) 2000-171707

(51) Int. Cl. G08B 3/00

(52) U.S. Cl. 340/384.1; 340/384.5

(57) ABSTRACT

A switch's click tone output unit is provided, which includes: a switch unit having a switch and an operation signal generating means to generate an operation signal when the switch is operated; a click tone signal generating means to generate a click tone signal including click tone information according to generation of the operation signal; and a tone outputting means to output a click tone corresponding to the click tone information, wherein a tone outputting means to output a tone corresponding to an audio tone signal generated by an audio unit and including audio tone information is applied as the tone outputting means to output the click tone. A switch's click tone outputting method includes a step of outputting a click tone from a tone outputting means for an audio system when a switch is turned on. And, an audio unit for a switch's click tone output unit includes: an audio tone signal generating means to generate an audio tone signal including audio tone information obtained from an audio system; and a click tone signal generating means to generate a click tone signal including click tone information having a same format as that of the audio tone signal according to an operation signal generated when a switch is turned on.

### BACKGROUND OF THE INVENTION

1. Field of the Invention

The present invention relates generally to a switch's click tone output unit, a switch's click tone outputting method, and an audio unit for the switch's click tone output unit and, more particularly, to a switch's click tone output unit to output a click tone of a switch installed in a vehicle, a switch's click tone outputting method, an audio unit for the switch's click tone output.

2. Description of the Related Art

An on-board equipment control unit shown in FIG. 8 is known as a switch's click tone outputting method. (In the present specification, a word “tone” expresses or includes the meaning of “sound”.) As shown, the on-board equipment control has an on-board equipment unit U1, a switch unit U2, and a switch unit U3, which are interconnected by a bus line L for making an intercommunication. The on-board equipment unit U1 has a microcomputer (hereinafter, μCOM) to which an onboard equipment 11 such as a car navigation system and an audio system is connected.

The switch unit U2 has a switch 21 provided at each of the driver's seat side and the passenger seat side to carry out the on/off operation of the on-board equipment 11, the μCOM 22 to generate or process various signals, and a speaker 23 to output a click tone according to a click tone signal outputted from the μCOM 22.

The switch unit U3 has a switch 31 provided at a rear seat side to carry out the on/off operation of the on-board equipment 11, the μCOM 32 to generate various signals, and a speaker 33 to output a click tone according to a click tone signal outputted from the μCOM 32.

The operation of the above system is described hereinafter.

First, when the switch 21 is operated at the driver's seat side or the passenger seat side, the μCOM 22 in the switch unit U2 outputs an ON operation signal to the on-board equipment unit U1 through the bus line L. When the μCOM 12 receives this ON operation signal, the μCOM 12 makes the on-board equipment 11 ON. The μCOM 22 outputs a click tone signal to the speaker 23 simultaneously with the output of the ON operation signal. The speaker 23 outputs a click tone corresponding to the click tone signal.

On the other hand, the μCOM 32 acts similarly to the μCOM 22 stated above when the switch 31 of the switch unit U3 is operated, and a click tone is outputted from the speaker 33. And, the operator can confirm that the switching operation has been securely carried out by listening to this click tone.

With respect to the above prior art switch's click tone outputting method, however, the speaker to output the click tone is to be provide in the switch unit, thereby increasing the cost. And, since a sufficiently large click tone is outputted from the speaker, the amplifiers are required for respective switches, thereby further increasing the cost.

### SUMMARY OF THE INVENTION

In view of the foregoing, an object of the present invention is to provide a switch's click tone output unit which can output a click tone with a volume being easy to listen, a switch's click tone outputting method, and an audio unit for the click tone output unit.

In order to achieve the above object, as a first aspect of the present invention, a switch's click tone output unit comprises: a switch unit having a switch and an operation signal generating means to generate an operation signal when the switch is operated; a click tone signal generating means to generate a click tone signal including click tone information according to generation of the operation signal; and a tone outputting means to output a click tone corresponding to the click tone information, wherein a tone outputting means to output a tone corresponding to an audio tone signal generated by an audio unit and including audio tone information is applied as the tone outputting means to output the click tone.

As a second aspect of the present invention, based on the first aspect, the switch unit, the click tone signal generating means, the tone outputting means, and the audio unit is interconnection by a multiplex line so as to transmit and receive signals therethrough.

As a third aspect of the present invention, based on the second aspect, the click tone signal generating means generates the click tone signal having a same format as that of the audio tone signal.

As a fourth aspect of the present invention, based on the first aspect, a plurality of switch units are provided, the tone outputting means has a plurality of speakers, and the click tone signal generating means generates the click tone signal making the speaker corresponding to the switch unit having outputted the operation signal output the click tone.

As a fifth aspect of the present invention, based on the fourth aspect, the click tone signal generating means changes at least a part of the audio tone information of the speaker corresponding to the switch unit having generated the operation signal. If the audio tone signal has been generated when the operation signal is generated.

As a sixth aspect of the present invention, a switch's click tone outputting method comprises a step of outputting a click tone from a tone outputting means for an audio system when a switch is turned on.

As a seventh aspect of the present invention, an audio unit for a switch's click tone output unit comprises: an audio tone signal generating means to generate an audio tone signal including audio tone information obtained from an audio system; and a click tone signal generating means to generate a click tone signal including click tone information having a same format as that of the audio tone signal according to an operation signal generated when a switch is turned on.

According to the above-described structures of the present invention, the following advantages are provided.

(1) Since the tone corresponding to the click tone information is outputted by applying the tone outputting means to output the tone based on the audio tone signal including the audio tone information obtained from the audio system, it is unnecessary to provide the tone outputting means for the switch and the tone outputting means for the audio system separately, thereby reducing the cost. Especially, when a large number of switches are required, a large cost reduction can be attained. Besides, since the tone outputting means for the audio system is applied to a means for outputting the click tone, the click tone of great volume sufficient for noisy circumstances can be outputted.

(2) Since the click tone of the switch can be outputted from the tone outputting means for the audio system by interconnecting the click tone signal generating means to the switch unit, the audio unit and the tone outputting means by the multiplex line, the structure becomes simple, thereby attaining further cost reduction.

(3) Since the click tone can be outputted by using the existing tone outputting means, the switch's click tone output unit with less cost can be obtained.

(4) Since the tone outputting means can make the speaker being not corresponding to the switch unit continue outputting the tone corresponding to the audio tone signal while making the speaker corresponding to the switch unit having outputted the operation signal output the click tone, the tone corresponding to the audio tone signal can be continued.

(5) Since the click tone can be outputted from the speaker corresponding to the operated switch unit by using the existing tone outputting means by means of changing a part of the audio tone information included in the audio tone signal of the speaker corresponding to the switch unit, still further cost reduction can be attained.

(6) It is unnecessary to provide the tone outputting means for the switch and the tone outputting means for the audio system separately, thereby reducing the cost. Especially, when a large number of switches are required, a large cost reduction can be attained. Besides, since the tone outputting means for the audio system is applied to a means for outputting the click tone, a switch's click tone outputting method securing the click tone of great volume sufficient for noisy circumstances can be attained.

(7) It is unnecessary to provide the tone outputting means for the switch and the tone outputting means for the audio system separately, thereby reducing the cost. Especially, when a large number of switches are required, a large cost reduction can be attained. Besides, since the tone outputting means for the audio system is applied to a means for outputting the click tone, the click tone of great volume sufficient for noisy circumstances can be outputted.

The above and other objects and features of the present invention will become more apparent from the following description taken in conjunction with the accompanying drawings.

### BRIEF DESCRIPTION OF THE DRAWINGS

FIG. 1 is a block diagram showing a basic structure of a switch's click tone output unit and an audio unit for the switch's click tone output unit of the present invention;

FIG. 2 is a block diagram of an on-board equipment control unit in which the switch's click tone output unit, to which the switch's click tone outputting method of the present invention is applied, and the audio unit for the switch's click tone output unit are assembled;

FIG. 3 is a flowchart showing a routine of the CPU in the switch unit of FIG. 2;

FIG. 4A and 4B each are a flowchart showing a routine of the CPU in the audio unit of FIG. 2;

FIG. 5 is a flowchart showing a routine of the CPU in the amplifier unit of FIG. 2;

FIG. 6 is a flowchart showing a routine of the CPU in the on-board equipment unit of FIG. 2;

FIGS. 7A-7F are schemata showing formats of various signals; and

FIG. 8 is a block diagram of an on-board equipment control unit using a prior art switch's click tone outputting method.

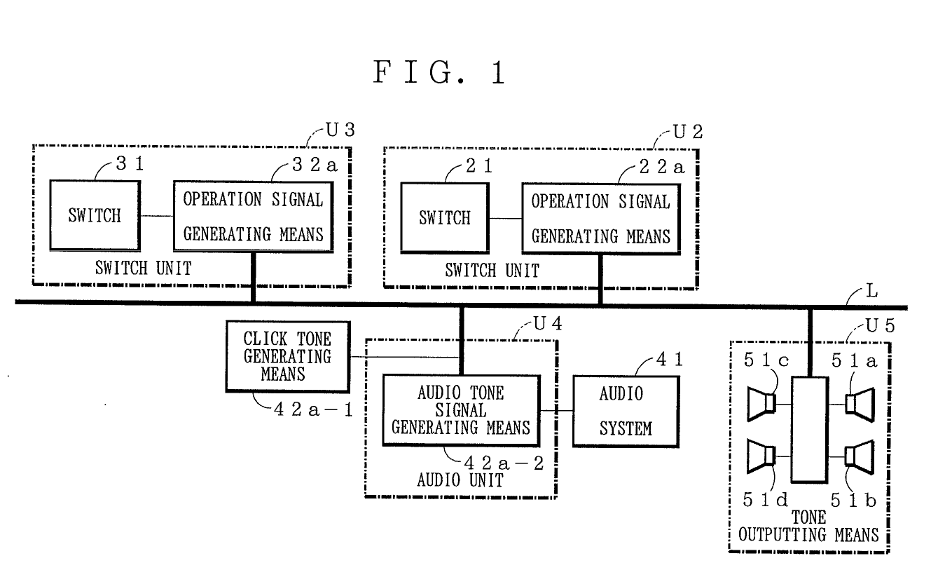

### DESCRIPTION OF THE PREFERRED EMBODIMENT(S)

An embodiment of the present invention will now be described in further detail with reference to the accompanying drawings.

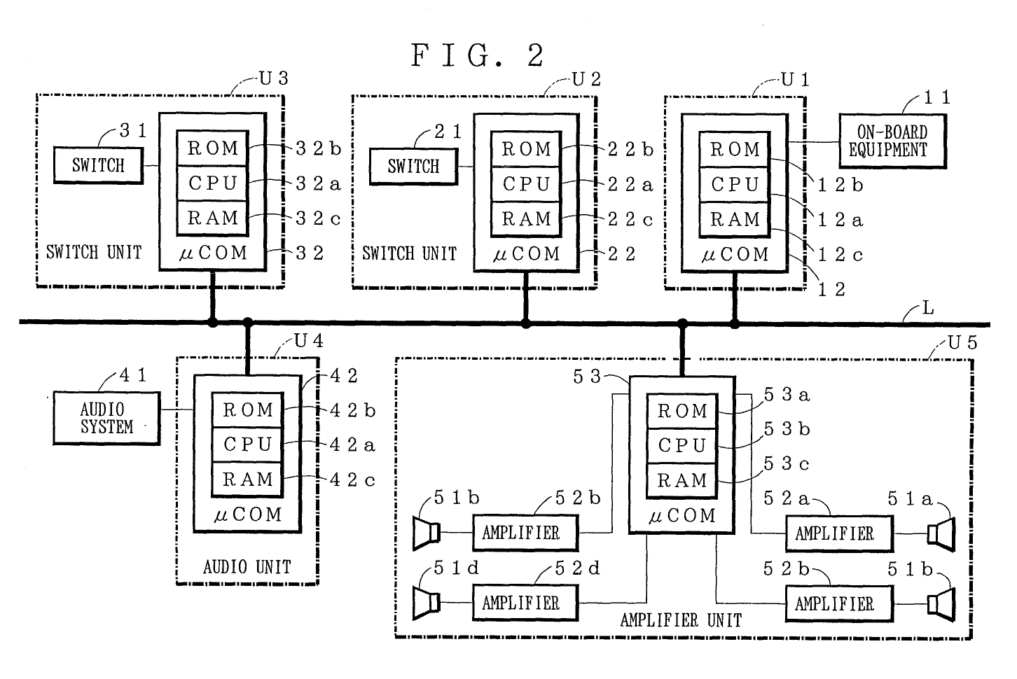

FIG. 2 is a block diagram of an on-board equipment control unit in which the switch's click tone output unit, to which the switch's click tone outputting method of the present invention is applied, and the audio unit for the switch's click tone output unit are assembled.

In the on-board equipment control unit, an on-board equipment unit U1, a switch unit U2 for both a driver's seat side and a passenger seat side, a switch unit U3 for a rear seat, an audio unit U4, and an amplifier unit U5 are interconnected by means of a multiplex line L for an intercommunication through the multiplex line L.

The above on-board equipment unit U1 has a microcomputer 12 (μCOM 12) to which an on-board equipment 11 such as a car navigation system and a television are connected. The switches 21, 31 have respective switch units U2,U3 for controlling the on-board equipment 11 and μCOMs 22, 32 to which the switch 21, 31 are connected. The above switch 21 is provided on both of the driver's seat side and the passenger seat side, and the switch 31 is provided on the rear seat side. The on-board equipment 11 are on-off controlled by the switches 21,31.

And, the audio unit U4 has a μCOM 42 to which an audio system 41 such as a radio and a CD player are connected. The amplifier unit U5 has speakers 51a-51d provided on the driver's seat side, the passenger seat side, the right rear seat side, and the left rear seat side, respectively, amplifiers 52a-52d provided for the respective speakers 51a-51d, and a μCOM 53 to which the speakers 51a-51d are connected through the amplifiers 52a-52d.

The μCOMs 12, 22, 32, 42 and 53 consist of CPUs 12a, 22a, 32a, 42a and 53a to work according to the determined control program, ROMs 12b, 22b, 32b, 42b and 53b holding the control program of the respective CPUs, and RAMs 12c, 22c, 32c, 42c and 53c to temporarily store necessary data for the instruction execution of the CPUs.

Each of the above CPUs 12a, 22a, 32a, 42a and 53a carries out a later-described generation processing to generate various signals, a transmission processing to send the generated signals to the multiplex line L, and a reception processing to take in addressed signals out of the received signals, to store them in the memory, and to send the remaining non-addressed signals to the multiplex line L.

In the switch units U2, U3, the CPUs 22a, 32a carries out an operation signal generating processing to generate an on-board equipment operation signal whenever the respective switches 21,31 are operated. In the audio unit U4, the CPUs 42a carries out an audio tone (or sound) signal generation processing to generate an audio tone (or sound) signal including audio tone (or sound) information obtained from the audio system 41 and a click tone signal generation processing to generate a click tone signal including, click tone information upon reception of an operation signal. And, in the amplifier unit U5, the CPU 53a carries out a tone (or sound) output processing to make the speakers 51a-51d output a tone (or sound) according to the received audio tone signal and the received click tone signal.

The action of the on-board equipment control unit is described by referring to the flowcharts shown in FIGS. 3-6 hereinafter.

FIG. 3 is a flowchart showing a routine of the CPUs 22a, 32a installed in the switch units U2, U3. First, an operator operates the switch 21 or 31 to on/off-operate the on-board equipment 11 (step S1a, YES). Then, each of the CPUs 22a, 32a generates the on-board equipment operation signal (step S1b).

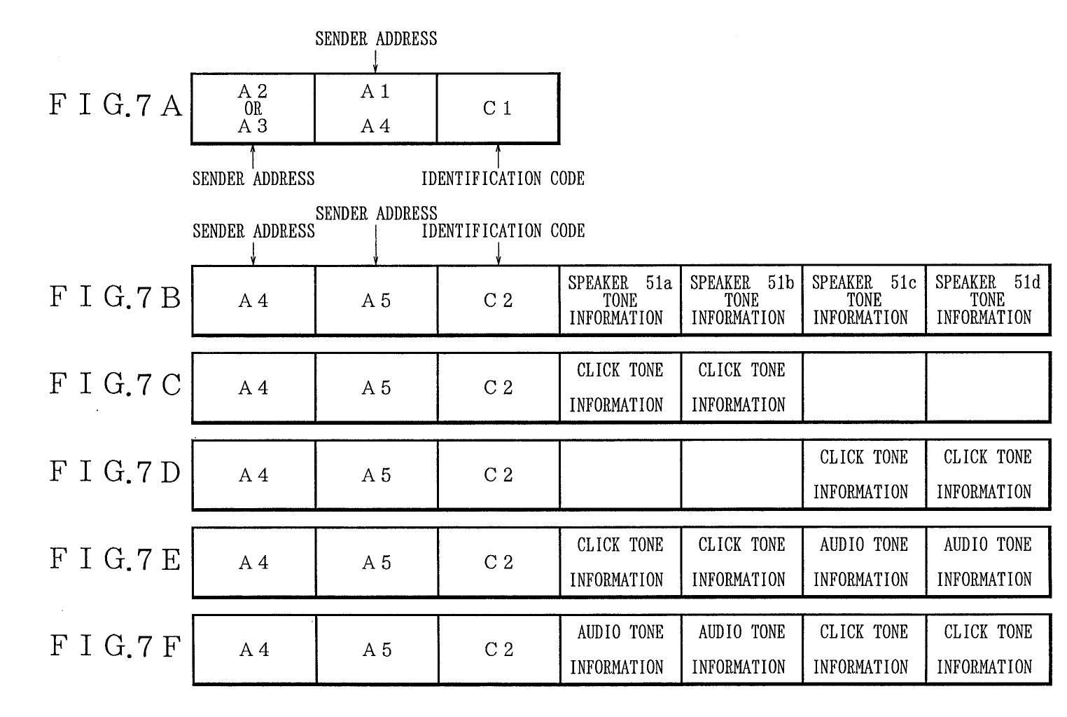

The on-board equipment operation signal, specifically as shown in FIG. 7A, consists of an address A2 or A3, i.e. original address, of the switch unit U2 or U3, an address A1, i.e. destination address, of the on-board equipment unit U1, an address A4 of the audio unit U4, and an identification code C1 showing that this signal is the on-board equipment operation signal.

On generating the on-board equipment operation signal, the CPUs 22a, 32a carries out a transmission processing to transmit that signal to the multiplex line L (step S1c) and returns to step S1a. As is clear from the operation shown in the flowchart of FIG. 3, the CPUs 22a, 32a forms an operation signal generating means which generates the operation signal when the switches 21,31 are operated.

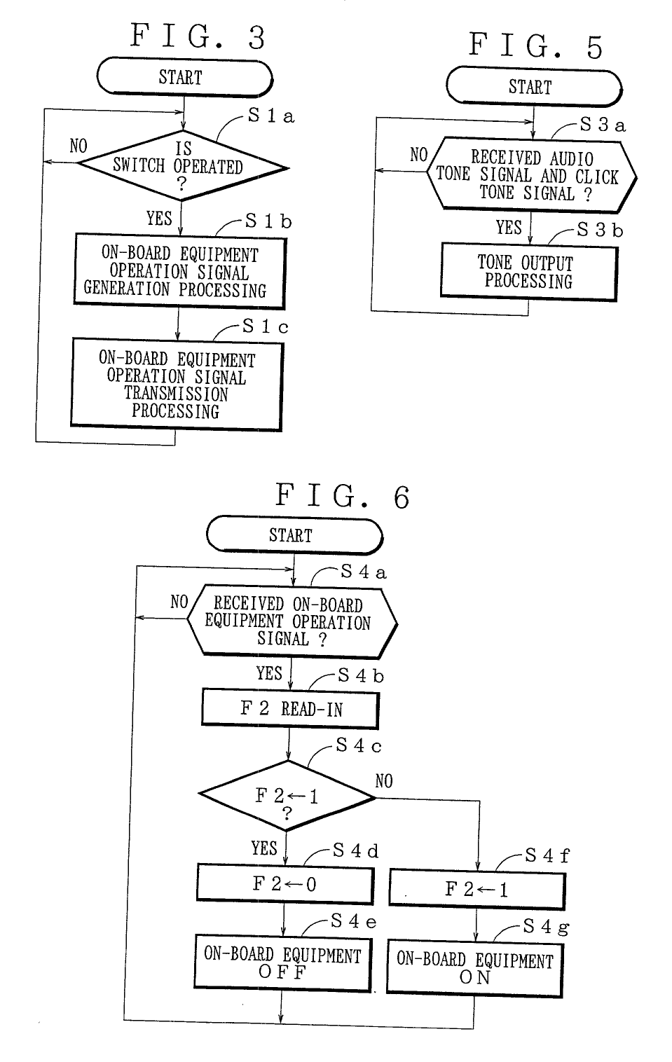

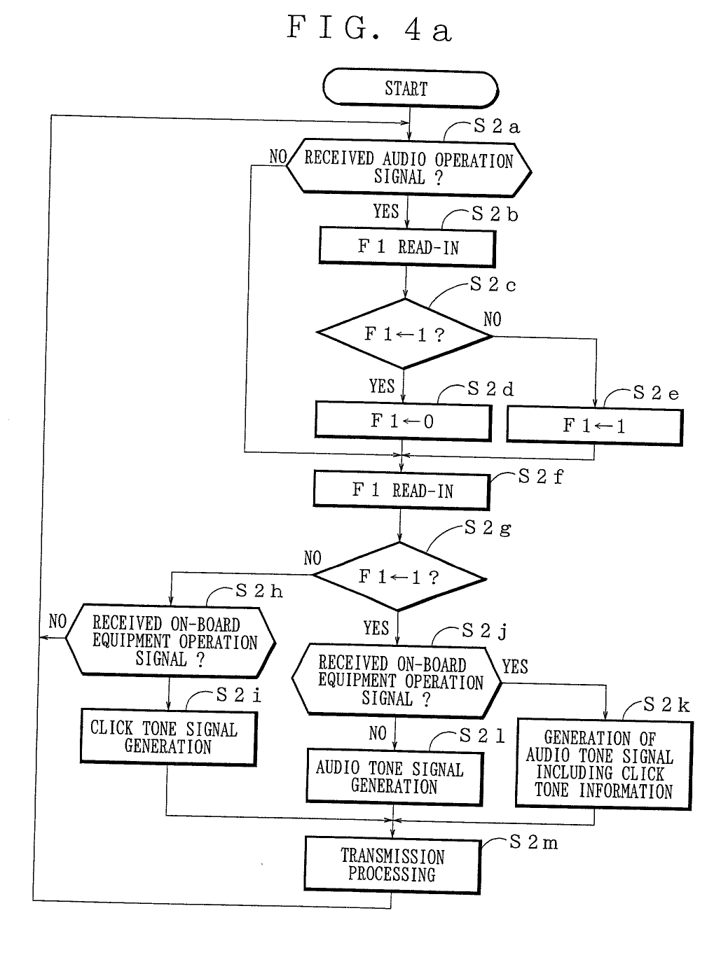

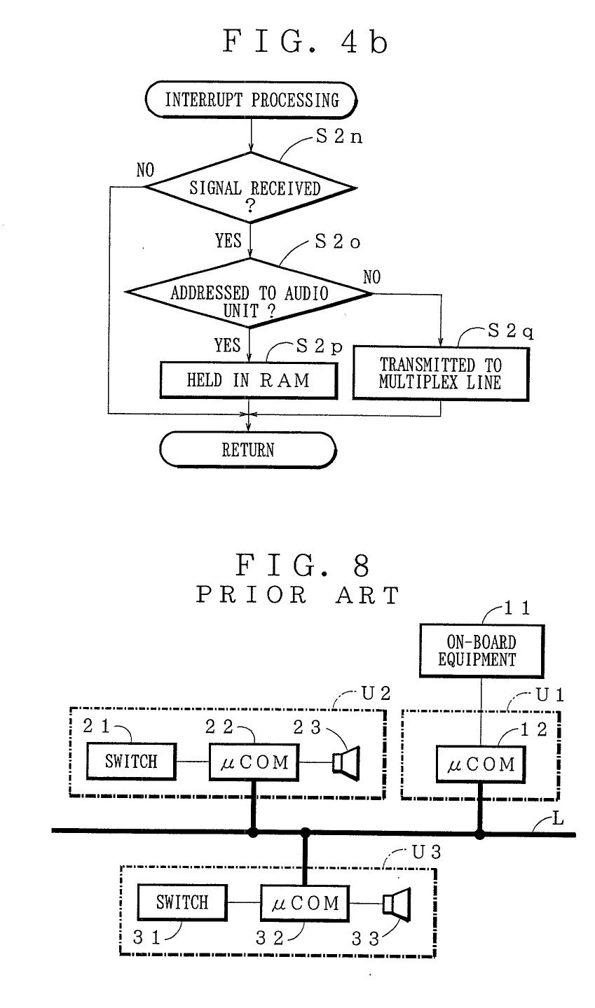

And, FIG. 4A is a flowchart, showing a routine of the CPU 42a installed in the audio unit U4. First, the CPUs 42a receives an audio operation signal and judges whether or not the audio operation signal is stored in the RAM 42c (step S2a). The above audio operation signal is generated when a non-shown audio switch to carry out on/off-operation of the audio system 41 is operated.

If the audio operation signal is received (step S2a, YES), the CPUs 42a reads in an the audio flag F1 showing an on/off state of the audio system 41 (step S2b). The audio flag F1 has 1 in an ON state of the audio system 41 and has 0 in an OFF state thereof.

The CPUs 42a judges the audio switch having been off-operated when the audio flag F1 has 1 (step S2c, YES) and gives 0 to the audio flag F1 (step S2d) in order to turn the audio system 41 into an OFF state.

On the other hand, the CPUs 42a judges the audio switch having been on-operated when the audio flag F1 has 0 (step S2c, ON) and gives 1 to the audio flag F1 (step S2e) in order to turn the audio system 41 into an ON state, and the process goes to step S2f. And, if the audio operation signal is not received (step S2a, NO), the process goes to step S2f.

The CPU 42a reads in a state of the audio flag F1 again in step S2f. When 0 is given to the audio flag F1 (step S2g, NO), the CPU 42a next judges whether or not the CPU 42a has received the on-board equipment operation signal from the switch unit U2 or U3 (step S2h). When the on-board equipment operation signal is received (step S2h, YES), the click tone signal including click tone information is generated (step S2i).

Similarly, when 1 is given to the audio flag F1 (step S2g, YES), the CPU 42a judges whether or not the CPU 42a has received the on-board equipment operation signal (step S2j). When the on-board equipment operation signal is received, an audio tone signal including both of audio tone information obtained from the audio system 41 and click tone information is generated (step S2k). And, if the on-board equipment operation signal has not been received, an audio tone signal including only the audio tone information from the audio system 41 is generated.

Then, the CPU 42a carries out the transmission processing to transmit the generated click tone signal and the generated audio tone signal to the multiplex line L (step S2m).

The click tone signal and the audio tone signal, as shown in FIG. 7B, each consist of an address A4, i.e. original address, of the audio unit U4, an address A5, i.e. destination address, of the amplifier unit U5, an identification code C2 showing that the signal is either the click tone signal or the audio tone signal, and tone information for each of the speakers 51a-51d. That is, the click tone signal and the audio tone signal have the same format.

Here, in step S2i, the CPU 42a stores the click tone information only in flames corresponding to the operated switches, which frames store the tone information of the respective speakers 51a-51d. That is, the CPU 42a judges whether the switch 21 was operated or the switch 31 was operated on the basis of a sender address (i.e. original address) of the on-board equipment operation signal.

And, when the CPU 42a judges that the switch 21 provided on the sides of driver's seat and the passenger seat was operated, the CPU 42a stores the click tone information in the flames (FIG. 7C) corresponding to the speakers 51a, 51b, which are closest to the respective driver's and passenger seats. Upon receiving the click tone signal with the above frame structure, the amplifier unit U5 makes only the speakers 51a,51b output the click tone.

On the other hand, when the switch 31 provided on the rear seat side is judged to be operated, the click tone information is stored in the flames (FIG. 7D) corresponding to the speakers 51c, 51don the side of the rear seat. Upon receiving the click tone signal, the amplifier unit U5 makes only the speakers 51c, 51doutput the click tone.

As the above, the click tone is outputted only from one, closest to the operated switch, of the speakers 51a-51d without a sense of incongruity.

Here, the audio tone signal including the click tone information and generated in step S2k is the following signal. That is, the click tone information is stores in the tone information flame of the speaker corresponding to the operated switch 21 or 31, and the audio tone information obtained from the audio system 41 is stored in the other tone information flames of the respective speakers. In other words, the audio tone signal is the one wherein the audio tone information of the speaker corresponding to the operated switch 21 or 31 is changed to the click tone information.

More specifically, as shown in FIG. 7E, when the switches 21 of the driver's seat and the passenger seat are operated, the click tone information is stored in the tone information flames of the respective speakers 51a, 51b. And, the audio tone information obtained from the audio system 41 is stored in the tone information flames of the respective speakers 51c, 51dof the rear seat. And, upon receiving the audio tone signal including the click tone information, the amplifier unit U5 makes the speakers 51a, 51b output the click tone and the speakers 51c, 51doutput tones (sounds) corresponding to the audio tone information.

On the other hand, when the switch 31 is operated, the audio tone information is stored in the tone information flames of the speakers 51a, 51b as shown in FIG. 7F, and the click tone information is stored in the tone information flames of the speakers 51c, 51d. And, upon receiving the audio tone signal including the click tone information, the amplifier unit U5 makes the speakers 51a, 51b output tones (sounds) corresponding to the audio tone information and the speakers 51c, 51doutput the click tone.

As apparent from the operation of the above-mentioned steps S2i, S2l and S2k, the CPU 42a has the click tone signal generating means and the audio tone signal generating means.

By making the CPU 42a generate the click tone signal and the audio tone signal, even if the switch 21 or 31 is operated when listening to a Compact Disc player (the audio system 41) for example, the click tone is outputted only from the one speaker closest to the operated switch 21 or 31, and the other speakers continue outputting, for example, a music without interrupting it.

Further, as stated above, since the click tone signal and the audio signal including both the click tone information and the audio tone information have the same format, the click tone can be outputted from the speaker corresponding to the operated switch by using the existing amplifier unit U5.

And, the above CPU 42a carries out the interrupt processing shown in FIG. 4B every predetermined period of time. The CPU 42a first judges whether or not a signal has been received in the interrupt processing (step S2n). If a signal has been received (step S2n, YES), the CPU 42a judges whether the signal is addressed to the audio unit (step S2o).

If the signal is addressed to the audio unit (step S2o, YES), the CPU 42a stores the signal in RAM42c (step S2p). If not (step S2o, NO), the signal is transferred to the multiplex line (step S2q), and the process makes the return (step S2q). On the other hand, a signal has not been received, the process immediately makes the return (step S2n, NO). With the above operation, a signal addressed to the audio unit from another unit can be stored in the RAM42c.

FIG. 5 is a flowchart showing a routine of the CPU 53a in the amplifier unit U5. First, the CPU 53a receives the click tone signal or the audio tone signal (step S3a, YES) and carries out a tone output processing (step S3b) to output the tone information of each of the speakers 51a-51d through the amplifiers 52a-52d, which tone information is included in the received signal.

By this operation, each of the speakers 51a-51d outputs a tone corresponding to the click tone information and the audio tone information included in the click tone signal and the audio tone signal, respectively. Accordingly, the amplifier unit U5 forms the tone outputting means.

The CPU 53a carries out a processing similar to the interrupt processing to be carried out by the audio unit U4 every predetermined period of time. That is, when the CPU 53a receives a signal addressed to the amplifier unit U5, the CPU 53a stores it in RAM53c. When the CPU 53a receives a signal not addressed to the amplifier unit U5, the CPU 53a transfers it to the multiplex line L. By this, a signal addressed to the amplifier unit U5 from another unit can be store in the RAM53c.

And, FIG. 6 is a flowchart showing a routine of the CPU 12a in the on-board equipment unit U1. First, the CPU 12a receives an on-board equipment operation signal (step S4a, YES) and reads in an on-board equipment flag F2 showing an on/off state of the on-board equipment 11 formed in the RAM12c (step S4b). This on-board equipment flag F2 has 1 in an ON state of the on-board equipment 11 and 0 in an OFF state thereof.

When the on-board equipment flag F2 has 1 (step S4c, YES), the CPU 12a judges the on-board equipment operation signal has been transmitted according to off-operation of the switch 21 or 31, gives 0 to the on-board equipment flag F2 (step S4d), and makes the on-board equipment 11 be an OFF state (step S4e). On the other hand, if 0 is set on the on-board equipment flag F2 (step S4c, NO), the CPU 12a judges the on-board equipment operation signal has been transmitted according to on-operation of the switch 21 or 31, gives 1 to the on-board equipment flag F2 (step S4f), and makes the on-board equipment 11 be an ON state (step S4g).

The CPU 12a carries out a processing similar to the interrupt processing to be carried out by the audio unit U4 every predetermined period of time. That is, when the CPU 12a receives a signal addressed to the on-board equipment unit U1, the CPU 12a stores it in the RAM12c. When the CPU 12a receives a signal not addressed to the on-board equipment unit U1, the CPU 12a transfers it to the multiplex line L. By this, a signal addressed to the on-board equipment unit U1 from another unit can be store in the RAM12c. The on-board equipment 11 is turned on/off according to the operation of the switch 21 or 31 in the switch unit U2 or U3, based on the above operation.

As stated above, since the click tone is outputted by applying the amplifier unit U5 for the audio system, it is unnecessary to provide an amplifier and a speaker for the switches 21,31 and the audio system separately, thereby reducing the cost. Especially, when a large number of switches are required, a large cost reduction can be attained.

In the present embodiment, since all the units are connected by means of the multiplex line, the click tone can be easily outputted from the amplifier unit U5 for the audio system when the switch is turned on.

In the present invention, however, the structure of the on-board equipment control unit is not limited to the one having the multiplex line L.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A switch's click tone output unit, comprising:
a switch unit having a switch and an operation signal generating means to generate an operation signal when the switch is operated;
a click tone signal generating means to generate a click tone signal including click tone information according to generation of the operation signal; and
a tone outputting means to output a click tone corresponding to the click tone information,
wherein a tone outputting means to output a tone corresponding to an audio tone signal generated by an audio unit and including audio tone information is applied as the tone outputting means to output the click tone.

2. The switch's click tone output unit as set forth in claim 1, wherein
the switch unit, the click tone signal generating means, the tone outputting means, and the audio unit is interconnection by a multiplex line so as to transmit and receive signals therethrough.

3. The switch's click tone output unit as set forth in claim 2, wherein
the click tone signal generating means generates the click tone signal having a same format as that of the audio tone signal.

4. The switch's click tone output unit as set forth in claim 1, wherein
a plurality of switch units are provided, the tone outputting means has a plurality of speakers, and the click tone signal generating means generates the click tone signal making the speaker corresponding to the switch unit having outputted the operation signal output the click tone.

5. The switch's click tone output unit as set forth in claim 4, wherein
the click tone signal generating means changes at least a part of the audio tone information of the speaker corresponding to the switch unit having generated the operation signal If the audio tone signal has been generated when the operation signal is generated.

6. A switch's click tone outputting method, comprising a step of:
outputting a click tone from a tone outputting means for an audio system when a switch is turned on.

7. An audio unit for a switch's click tone output unit, comprising:
an audio tone signal generating means to generate an audio tone signal including audio tone information obtained from an audio system; and
a click tone signal generating means to generate a click tone signal including click tone information having a same format as that of the audio tone signal according to an operation signal generated when a switch is turned on.
